(19) United States
(12) Patent Application Publication
(10) Pub. No.: US 2026/0052167 A1
(43) Pub. Date: Feb. 19, 2026

(54) SYSTEMS AND METHODS FOR IDENTIFYING DATA SECURITY THREATS AND DYNAMICALLY GENERATING VULNERABILITY SOLUTIONS

(71) Applicant: BANK OF AMERICA CORPORATION, Charlotte, NC (US)

(72) Inventors: Jennie Egbert, Ventura, CA (US); Scott Fennell, Carrollton, TX (US)

(73) Assignee: BANK OF AMERICA CORPORATION, Charlotte, NC (US)

(21) Appl. No.: 19/299,934

(22) Filed: Aug. 14, 2025

Related U.S. Application Data
(60) Provisional application No. 63/682,975, filed on Aug. 14, 2024.

(51) Int. Cl. H04L 9/40; H04L 41/16

(52) U.S. Cl. CPC H04L 63/1433; H04L 41/16; H04L 63/1425

(57) ABSTRACT

Systems, computer program products, and methods are described herein for identifying data security threats and dynamically generating vulnerability solutions. The present invention is configured to identify a current data transmission; apply the current data transmission to an artificial intelligence (AI) engine, wherein the AI engine is pre-trained with at least one historical dataset; assign, by the AI engine, at least one attribute to the current data transmission, wherein the at least one attribute comprises a group attribute, technology attribute, an AI attribute, or a network attribute; and generate, based on the assigned at least one attribute to current data transmission, an attribute map, wherein the attribute map comprises an attribute node for each of the at least one attribute, and at least one edge between at least two attribute nodes.

### CROSS-REFERENCE TO RELATED APPLICATIONS

This application claims the benefit of U.S. Provisional Patent Application Ser. No. 63/682,975, filed Aug. 14, 2024, entitled “Systems And Methods For Identifying Data Security Threats And Dynamically Generating Vulnerability Solutions”, the entirety of which is incorporated herein by reference.

### FIELD OF THE INVENTION

The present invention embraces a system for identifying data security threats and dynamically generating vulnerability solutions.

### BACKGROUND

In today's electronic environment where many communications occur across a network and remotely between users, confirming that the communications do not comprise any data security threats can be increasingly difficult. Further difficulties arise when artificial intelligence (AI) engines are introduced by threat actors and improve their data security threat attempts by making any indicators that may have been visible to the human eye (e.g., misspellings in emails asking for secure information) now non-existent. Thus, such data security threats which are improved by AI engines may now be completely unidentifiable to the human eye. Thus, there exists a great need for a system that can efficiently, accurately, and securely identify data security threats and dynamically generate vulnerability solutions.

Applicant has identified a number of deficiencies and problems associated with identifying data security threats and solutions to resolve the data security threats. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for identifying data security threats and dynamically generating vulnerability solutions is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify a current data transmission; apply the current data transmission to an artificial intelligence (AI) engine, wherein the AI engine is pre-trained with at least one historical dataset; assign, by the AI engine, at least one attribute to the current data transmission, wherein the at least one attribute comprises a group attribute, technology attribute, an AI attribute, or a network attribute; and generate, based on the assigned at least one attribute to current data transmission, an attribute map, wherein the attribute map comprises an attribute node for each of the at least one attribute, and at least one edge between at least two attribute nodes.

In some embodiments, the at least one attribute map comprises a group attribute set which comprises a plurality of attributes comprising at least one of the technology attribute, the AI attribute, the network attribute.

In some embodiments, the at least one historical dataset comprises at least one of threat positive internal historical data, threat negative internal historical data, public historical data, or darknet historical data.

In some embodiments, the current data transmission comprises at least one of a text message data transmission, an electronic mail data transmission, an audio data transmission, an audio-visual data transmission, or a software data transmission.

In some embodiments, executing the computer-readable code is further configured to cause the at least one processing device to: determine the current data transmission has been assigned the AI attribute indicating the current data transmission is generated by a secondary AI engine, wherein the AI attribute assignment is based on a confidence level of the AI engine or a AI positive threshold; apply, based on the assigned AI attribute to the current data transmission, the AI engine to the current data transmission; trigger, based on applying the AI engine to the current data transmission, at least one AI-generated communication to a sender of the current data transmission; and collect response data from the sender based on the at least one AI-generated communication. In some embodiments, executing the computer-readable code is further configured to cause the at least one processing device to: update the historical dataset with the response data from the sender; and retrain the AI engine based on the response data. In some embodiments, executing the computer-readable code is further configured to cause the at least one processing device to: parse the response data; assign at least one attribute to the parsed response data; and update the attribute map with at least one node associated with the at least one attribute of the parsed response data.

In some embodiments, executing the computer-readable code is further configured to cause the at least one processing device to: analyze, by the AI engine, the attribute map comprising a plurality of nodes and a plurality of edges between the plurality of nodes, wherein one node comprises the group attribute; and generate at least one actor pattern associated with the group attribute, wherein the actor pattern is based on a collection of the plurality of nodes connected by a plurality of edges to the node comprising the group attribute.

In some embodiments, executing the computer-readable code is further configured to cause the at least one processing device to: identify a resource transmission based on at least one of the current data transmission or a historical data transmission; determine the resource transmission was transmitted to a resource account associated with a group attribute from the attribute map; trace the resource transmission from the resource account associated with the group attribute as the resource transmission is transmitted partially or wholly to a third-party resource account; determine the third-party resource account is associated with at least one node in the attribute map; and update the attribute map with an edge between the node associated with group attribute and node associated with the node associated with the third-party resource account.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for identifying data security threats and dynamically generating vulnerability solutions, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for identifying data security threats and dynamically generating vulnerability solutions, in accordance with an embodiment of the disclosure;

FIG. 4 illustrates a process flow for collecting response data based on the AI-generated communication, in accordance with an embodiment of the disclosure;

FIG. 5 illustrates a process flow for training an AI engine with response data and/or updating the attribute map based on the response data, in accordance with an embodiment of the disclosure;

FIG. 6 illustrates a process flow for generating an actor pattern associated with a group attribute, in accordance with an embodiment of the disclosure; and

FIG. 7 illustrates a process flow for updating the attribute map based on tracing a resource transmission, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource transfer,” “resource transmission,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

In today's electronic environment where many communications occur across a network and remotely between users, confirming that the communications do not comprise any data security threats can be increasingly difficult. Further difficulties arise when artificial intelligence (AI) engines are introduced by threat actors and improve their data security threat attempts by making any indicators that may have been visible to the human eye (e.g., misspellings in emails asking for secure information) now non-existent (as AI engines are used, the indicators often used for determining cyberattacks such as misspellings in emails, urgency, external email indicators, and/or the like, may be fixed before the recipient receives the data transmissions). Thus, such data security threats which are improved by AI engines may now be completely unidentifiable to the human eye. Thus, there exists a great need for a system that can efficiently, accurately, and securely identify data security threats and dynamically generate vulnerability solutions.

Accordingly, the present disclosure provides for the identification a current data transmission; the application of the current data transmission to an artificial intelligence (AI) engine, wherein the AI engine is pre-trained with at least one historical dataset; the assignment, by the AI engine, of at least one attribute to the current data transmission, wherein the at least one attribute comprises a group attribute, technology attribute, an AI attribute, or a network attribute; and the generation, based on the assigned at least one attribute to current data transmission, of an attribute map, wherein the attribute map comprises an attribute node for each of the at least one attribute, and at least one edge between at least two attribute nodes.

In other words, the disclosure provides a system using various AI engines to perform continuous monitoring of different platforms, such as but not limited to open source platforms, the dark web, internal and external systems, and/or the like, to generate and analyze a comprehensive AI library of data points of threats and non-threats. Specifically, the disclosure trains an AI engine to identify data security threats such as AI-generated audio deepfakes, AI-generated malware, AI-generated cyberattacks, and/or the like. Further, the disclosure generates threat vectors and patterns for particular users, entities, and/or the like, which may be linked based on shared systems, third party services, AI service providers and AI engines, networks, and/or the like, which may be used to add an extra layer of information identifying the capabilities of each group and entity. Further, and in some embodiments, the disclosure may provide different vulnerability solutions based on the data security threat (e.g., based on the types of technology used for the data security threats, based on the identifier of the user or entity known for the data security threat, based on data gathered by the AI engine(s) interacting with the data security threat system, and/or the like), the system may apply its own AI engine to correspond with the secondary AI engine of the threat actor, gather data and information from the correspondence, generate a warning notification for the recipient user of the data transmission, and/or the like.

What is more, the present invention provides a technical solution to a technical problem. As described herein, the technical problem includes the identification of data security threats and solutions to resolve the data security threats. The technical solution presented herein allows for the automatic, efficient, accurate, and secure identification of data security threats and generation of vulnerability solutions. In particular, the disclosure is an improvement over existing solutions to data security threats, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

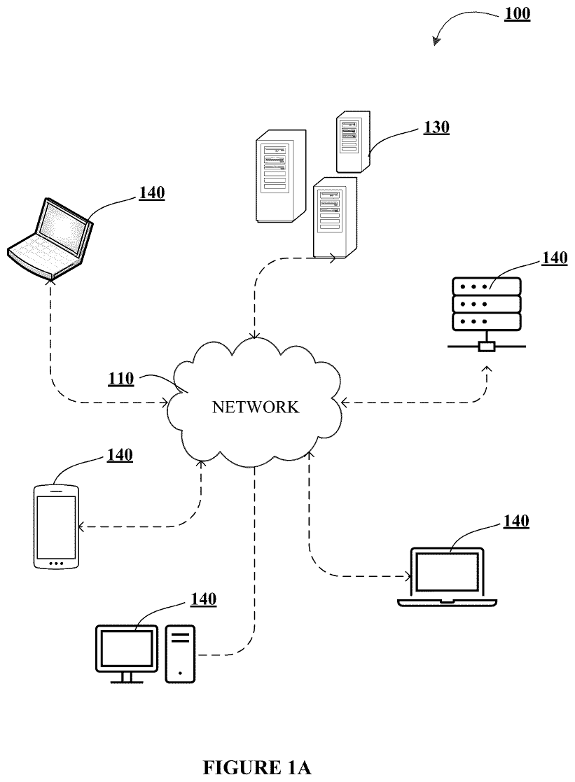

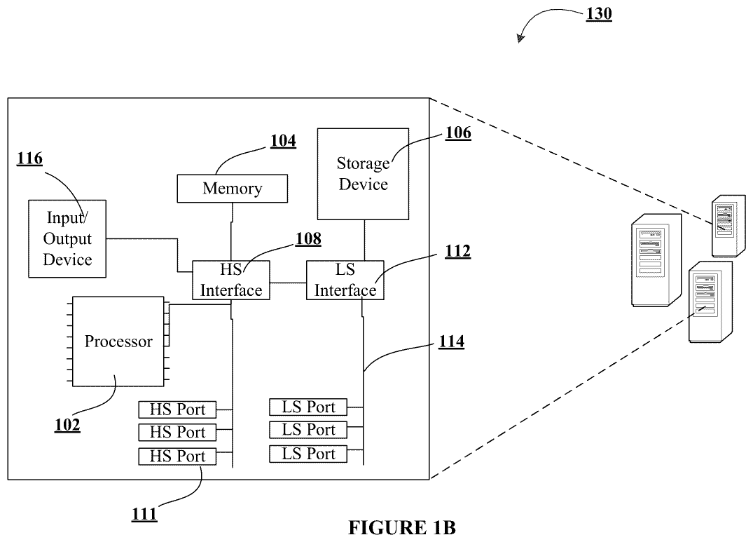

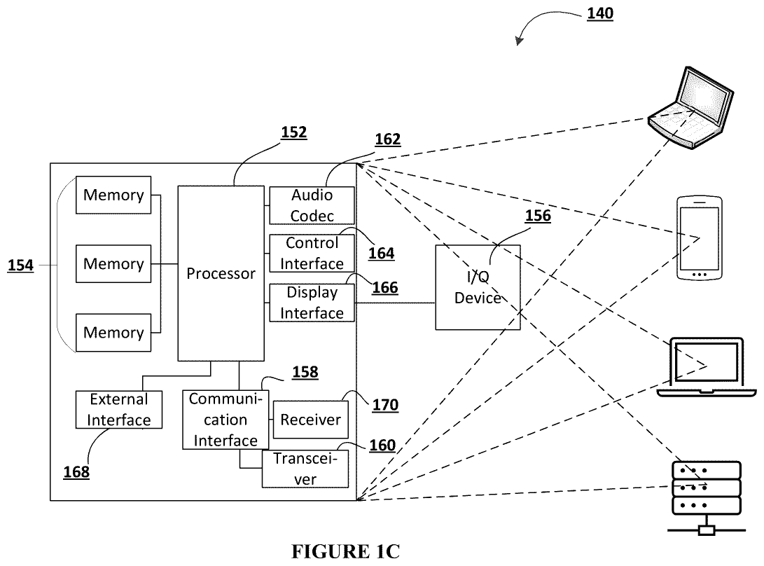

FIGS. 1A-1C illustrate technical components of an exemplary distributed computing environment for identifying data security threats and dynamically generating vulnerability solutions 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

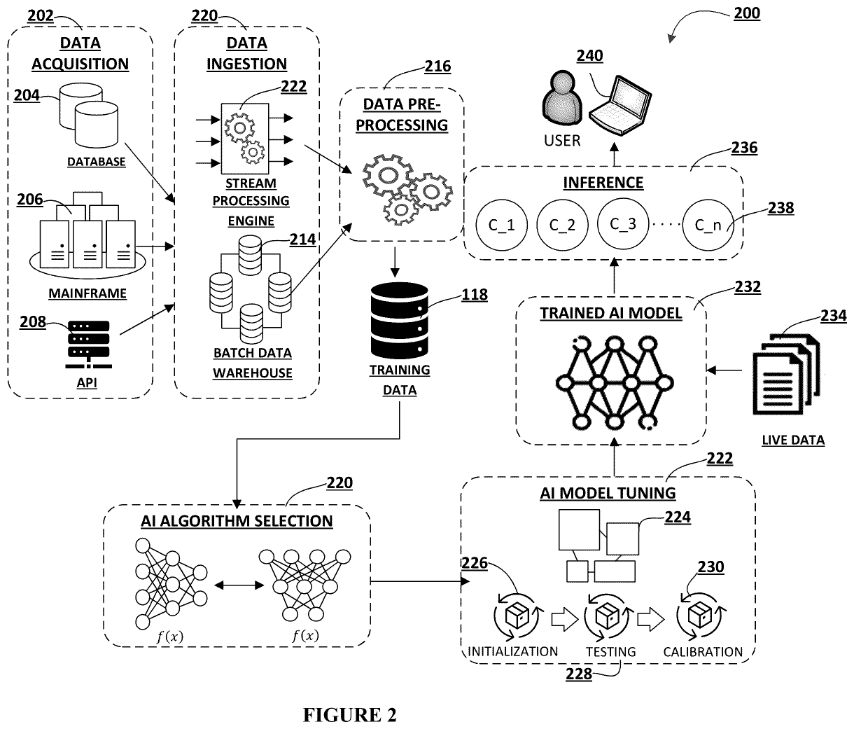

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

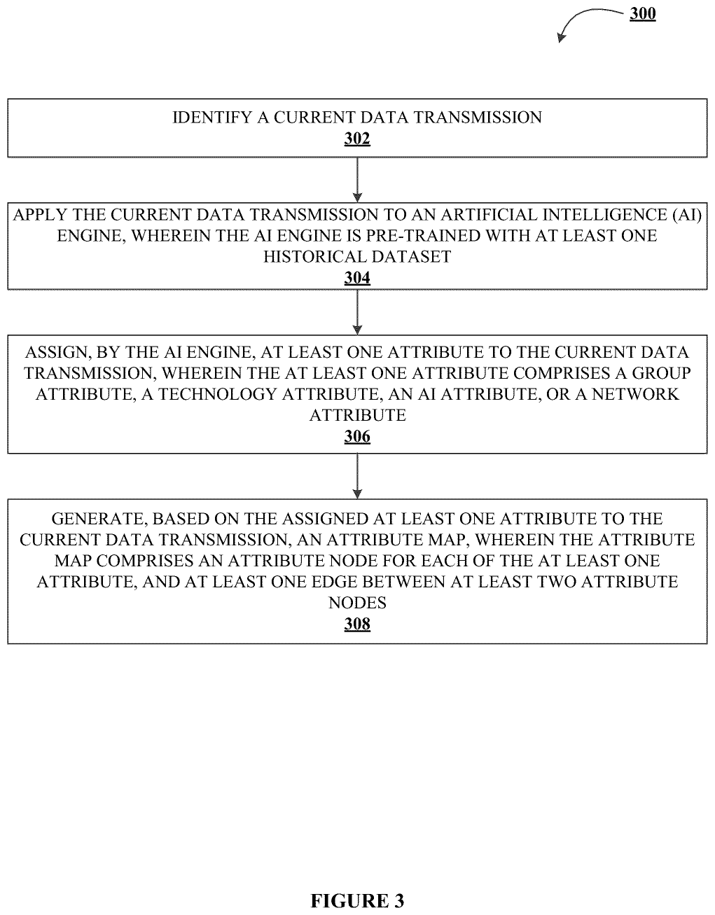

FIG. 3 illustrates a process flow 300 for identifying data security threats and dynamically generating vulnerability solutions, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of identifying a current data transmission. For instance, and as used herein, a current data transmission refers to a communication transmission between at least two user devices, two entities, and/or the like, whereby the communication transmission occurs over a network, such as the network 110 of FIG. 1A. For example, and in some embodiments, the current data transmission may comprise an electronic mail data transmission (e.g., an email, and/or the like) transmission, an audio transmission (e.g., a recording, a phone call, and/or the like), an audio-visual data transmission, a text message data transmission (e.g., a text message, SMS, an instant message, and/or the like), a software transmission (e.g., malware, and/or the like), and/or the like.

In some embodiments, the system may identify the current data transmission based on identifying each current data transmission that enters a network a recipient device is associated with (e.g., a recipient user device that could receive an email, a text message, a phone call, and/or the like). In some embodiments, the system may be installed on a recipient device and the system may identify each data transmission as it is received on the recipient user device. In some embodiments, a database may be generated and continuously updated for each data transmission received within a network of recipient user devices, and the system may continuously access and retrieve the data for each data transmission as each data transmission is identified in the network.

As shown in block 304, the process flow 300 may include the step of applying the current data transmission to an artificial intelligence (AI) engine, wherein the AI engine is pre-trained with at least one historical dataset. For example, the system may comprise an AI engine which is pre-trained with at least one historical dataset (or continuously with a plurality of historical datasets), whereby the AI engine is configured and trained to assign an attribute(s) to the data transmission(s) (current and/or historical). For example, the AI engine may be pre-trained at least at an initial instance with at least one historical dataset that comprises a collection of historical data regarding historical data transmissions. In some embodiments, the historical dataset may comprise at least one of threat positive internal historical data (e.g., historical communication data from a threat actor, a historical resource transmission to a threat actor account, historical technology used by threat actors, and/or the like), threat negative internal historical data (e.g., determined historical communication data that has been determined to not have occurred from a threat actor and is determined as safe, historical technology determined to have not been used by threat actors), public historical data (e.g., public or open source data of historical threat actor interactions, communications, technology used, and/or the like), and/or darknet historical data (e.g., historically identified threat actors and their accounts, historically identified threat actor technology, networks, communication data, and/or the like).

In some embodiments, the AI engine may be pre-trained and/or continuously or iteratively trained with the historical datasets and/or current datasets are collected. Thus, and in such embodiments, the AI engine may be pre-trained and the continuously trained as data is collected and determined (such as through a feedback loop) as from a threat actor or not from a threat actor. As the AI engine is continuously trained, the AI engine may refine itself by revising its weights and other such decision factors to more accurately make determinations on the current data transmissions, assign attributes to the current data transmission, based on the AI engine's confidence level (e.g., the confidence of the AI engine to make determinations and assign attributes accurately).

As shown in block 306, the process flow 300 may include the step of assigning, by the AI engine, at least one attribute to the current data transmission, wherein the at least one attribute comprises a group attribute, a technology attribute, an AI attribute, or a network attribute. For instance, the system may—using the AI engine—assign at least one attribute to the current data transmission, whereby the attributes assigned may be used as a descriptor for the current data transmission such as a group descriptor (e.g., an identifier of a threat actor group that created the current data transmission, an identifier of a trusted group that created the current data transmission, and/or the like), and/or the like. Thus, the attributes that may be assigned to the current data transmission may comprise a group attribute (i.e., the group descriptor); a technology attribute (e.g., a technology descriptor or identifier of technology used in generating or carrying out the current data transmission, such as but not limited to specific computer component identifiers, third party vendor identifiers, system identifiers, and/or the like); an AI attribute (e.g., an AI engine descriptor or identifier of AI technology used to generate partially or completely the current data transmission, which may also indicate whether the current data transmission was generated by an AI engine at all if this attribute is assigned); a network attribute (e.g., a descriptor or identifier of the network that generated the current data transmission, such as internet protocol (IP) address that generated the current data transmission); and/or the like.

Thus, and in some such embodiments, the AI engine may assign one attribute or a plurality of attributes to each current data transmission. In some such embodiments, the AI engine may assign each attribute to the current data transmission based on parsing the current data transmission and its underlying data (e.g., IP address information, device identifier that generated and/or transmitted the current data transmission, data used to determine the group attribute/identifier, and/or the like). In some embodiments, the AI engine may determine the group attribute based on parsing the data of the current data transmission, including but not limited to the request for particular data in the current data transmission by the recipient user of the recipient user device, the IP address of the current data transmission, timestamp of the current data transmission, geographic data of the current data transmission generation, current data transmission duration (e.g., phone call duration), destination of the current data transmission (e.g., specific recipient user device), technology data (e.g., phone number used to transmit the current data transmission from, and/or the like). In some embodiments, the data considered and analyzed by the AI engine may comprise a communication service provider identifier (which may have been used for previous group identifiers that have historically generated data transmissions), a phone number reputation determination and scoring (based on historical data transmissions, which may have previously been associated with threat positive data transmissions), and/or the like. Additionally, and in some embodiments, the AI engine may be trained to determine whether the phone number is unknown from historical data transmissions, history of previous communication channels (e.g., phone, text message, email, and/or the like), data communication frequency (how often the phone number and/or device identifier have communicated and sent data transmissions in the past, and whether the latest frequency of data communication is an anomaly), receiver data communication frequency (how often a receiver received data transmissions within a predefined time, how often emails were received by recipients in a predefined period, how often emails were received by one account or user device in a predefined period), speaker recognition (e.g., recognizing the speaker in the data transmission based on historical data transmissions and voice recognition), speech recognition (e.g., specific phrases, terms, accents, shorthand phrases, and/or the like, that may be used to recognize a user), un-natural speech recognition (e.g., urgency, grammar, and/or the like), and/or requesting sensitive information (e.g., personally identifiable information, resource account information and/or credentials, and/or the like), header analysis (e.g., based on headers and/or subject line identification within an email, the AI engine may determine if a particular threat group likely generated the email, and/or the like).

As shown in block 308, the process flow 300 may include the step of generating, based on the assigned at least one attribute to the current data transmission, an attribute map, wherein the attribute map comprises an attribute node for each of the at least one attribute, and at least one edge between at least two attribute nodes. For instance, the system may—in response to assigning an attribute(s) to the current data transmission—generate and/or update an attribute map to show the overall picture for each threat group, their associated attributes (e.g., technology the threat groups have used in the past and/or currently, AI engines used in the past or currently, their strategies and/or tactics used, their communication styles, their associated groups and known third parties they associate with and work with, and/or the like). Thus, and as used herein, the attribute map may comprise and be organized by group attribute, with each attribute being associated with a node within the attribute, and each relationship between the group and their known technology attributes, AI attributes, third party (e.g., other group attributes), network attributes, and/or the like, may be shown by edges between the attributes. In this way, the attribute map is a comprehensive view or report for each and every threat actor group, their associations with other threat actors and/or third parties, their capabilities and known technology capabilities, and/or the like.

In some embodiments, the at least one attribute map may comprise a group attribute set which comprises a plurality of attributes comprising at least one of the technology attribute, the AI attribute, the network attribute. For example, and in some such embodiments, the system may generate the attribute map to comprise a grouping of attributes associated with one group attribute in their own sectioned off grouping of nodes away from another group attribute node's grouping, whereby only an edge(s) may connect attributes between the groups of nodes. In this manner, the attribute map may separate each group attribute's node and their associated attribute nodes, and form a plurality of attribute maps within the overall attribute map (where each attribute map within the overall attribute map is associated with a specific node for a specific group attribute).

In some embodiments, the system may generate the attribute map based on the assigned attribute(s) for the historical data transmissions and each of the current data transmissions using the AI engine, using graph theory, and/or using other such algorithms designed to generate a graph or map between each node associated with an attribute and each edge indicating the relationship and/or link between each node.

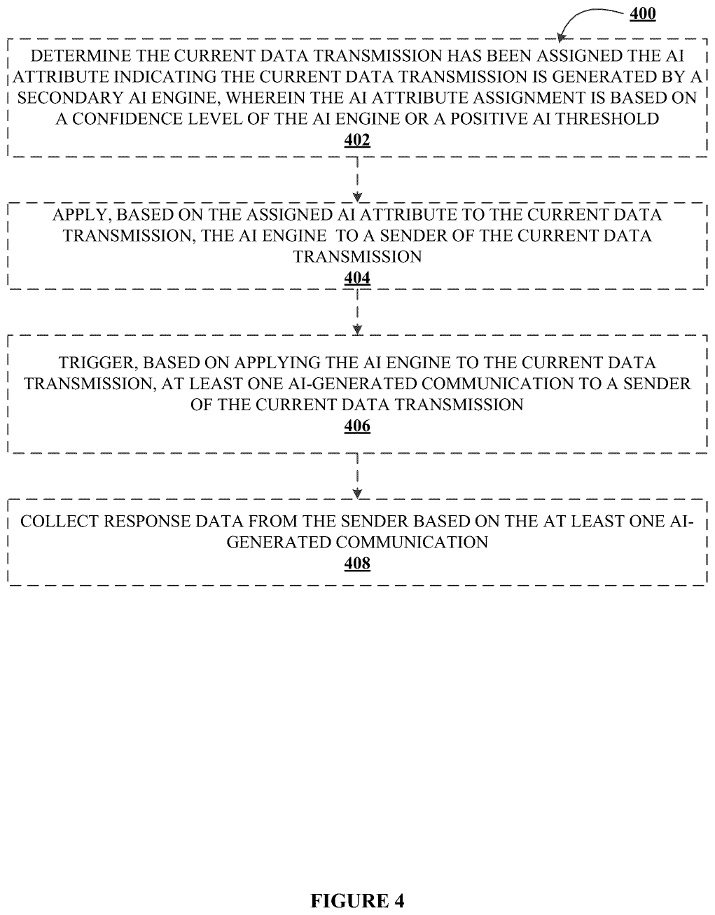

FIG. 4 illustrates a process flow 400 for collecting response data based on the AI-generated communication, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400.

In some embodiments, and as shown in block 402, the process flow 400 may include the step of determining the current data transmission has been assigned the AI attribute indicating the current data transmission is generated by a secondary AI engine, wherein the AI attribute is based on a confidence level of the AI engine or a positive AI threshold. For instance, and in some such embodiments, the system may determine the current data transmission has been assigned to an AI attribute, which indicates that the current data transmission (e.g., the data transmission received at a first instance or at continuous instances within a phone call, a text message conversation, email conversation, and/or the like) was partially and/or completely generated with the help with a secondary or other AI engine separate from the AI engine used by the system described herein (e.g., the AI engine described hereinabove for FIG. 3). As used herein, the term “secondary AI engine” refers to an AI engine that was separately configured and/or trained by another entity outside of the network that received the current data transmission, which may indicate the secondary AI engine is outside the network that received the data transmission and thus, may be from a threat actor attempting to gain access to information known within the network or known to users of the network.

Additionally, and in some embodiments, the AI engine (i.e., the AI engine of the recipient network) may comprise a confidence level which may update continuously based on the training data it receives and processes, based on each assignment of attributes for each data transmission, and/or based on a feedback loop which may agree or disagree with the assignment of each of the attributes. As the AI engine improves upon itself with each current data transmission and its associated attribute assignments, the system may configure a feedback loop to the AI engine to receive feedback (such as from a manager of the system, a client of the system, the system itself based on monitoring later activities with the current data transmission and/or the like), which may be used to retrain the AI engine and improve the confidence level of the AI engine. In some embodiments, and before allowing use of the AI engine in the system described herein, the system may require the AI engine's confidence level to be at least one of 60%, 65%, 75%, 80%, 85%, 90%, 95%, and/or the like. Thus, and in such embodiments, the system may confirm the AI attribute for the current data transmission when the confidence level of the AI engine assigning the attributes is above a confidence level threshold (e.g., 60%, 65%, 75%, 80%, 85%, 90%, 95%, and/or the like).

Additionally, and/or alternatively, the system may affirm the attribute assignment for the current data transmission based on a positive AI threshold. For example, and in such an embodiment, a positive AI quality determination may be determined as a quantifiable number showing the likelihood of the AI attribute being positive for the current data transmissions. Such a positive AI quality determination may be generated by the AI engine after analyzing the current data transmission and its underlying data to determine whether the current data transmission was likely generated by a secondary AI engine (completely and/or partially), and upon assigning an AI attribute to the current data transmission, the AI engine may generate a quality score (e.g., a positive AI quality determination) for the likelihood that the AI engine determined the secondary AI engine generation correctly. In some such embodiments, the positive AI threshold may be predetermined by a client of the system, by a manager of the system, and/or by the system itself (e.g., based on a feedback loop and historical data transmissions and their correctly identified attributes and/or incorrectly identified attributes).

In some embodiments, and as shown in block 404, the process flow 400 may include the step of applying, based on the assigned AI attribute to the current data transmission, the AI engine to a sender of the current data transmission. For example, and in some embodiments, the system may apply the AI engine to a sender of the current data transmission, whereby the process of applying the AI engine to the sender may comprise the AI engine generating responses to the current data transmission and its requests (e.g., conversation, requests, and/or the like). In this manner, and in some embodiments, upon determining that the current data transmissions was generated by a secondary AI engine, the system may automatically apply its AI engine to converse with and/or send its own response data transmissions to the secondary AI engine. Further, and as the AI engine is conversing with the secondary AI engine, the AI engine of the system may continuously collect and parse each piece of data received from the secondary AI engine for further analysis, further storing with historical datasets, further attribute assignment, and/or the like.

In some embodiments, and as shown in block 406, the process flow 400 may include the step of triggering, based on applying the AI engine to the current data transmission, at least one AI-generated communication to a sender of the current data transmission. For instance, and in some embodiments, the system may trigger the response(s) (i.e., AI-generated communication) from the AI engine of the system to the secondary AI engine and/or to the secondary AI engine and an associated threat user (where the secondary AI engine only partially generated the current data transmission). In some embodiments, multiple data transmissions may be transmitted between the secondary AI engine and the AI engine of the system during the current data transmission period, whereby the current data transmission period may comprise all the data transmissions between the recipient user device and/or AI engine in the recipient network and the network that generated/transmitted the current data transmission. In some embodiments, the current data transmission period my start at the first identification of the current data transmission and my end after a predefined period of non-response (e.g., a 24 hour period after a latest text message, 24 hours after a latest email, and/or the like).

In some embodiments, and as shown in block 408, the process flow 400 may include the step of collecting response data from the sender based on the at least one AI-generated communication. For example, and in some such embodiments, the system may collect the response data from the sender network of the current data transmission (e.g., the secondary AI engine and/or the threat user) as the AI engine interacts with and transmits responses to the sender network. Each response received from the sender network may be individually and/or collectively parsed by the AI engine, attributes may be assigned, and the attribute map may be updated. In some embodiments, and in an instance where the responses are collectively parsed after all the responses have been received, the system may parse the response data, assign the attributes, and update the attribute map after the responses have all been received and collected. In this manner, and in some embodiments, the system may only assign attributes and update the attribute map in one instance, such that the attribute map does not need to be accessed and updated multiple times in a short period of time, which may in turn save computing resources and network capacity.

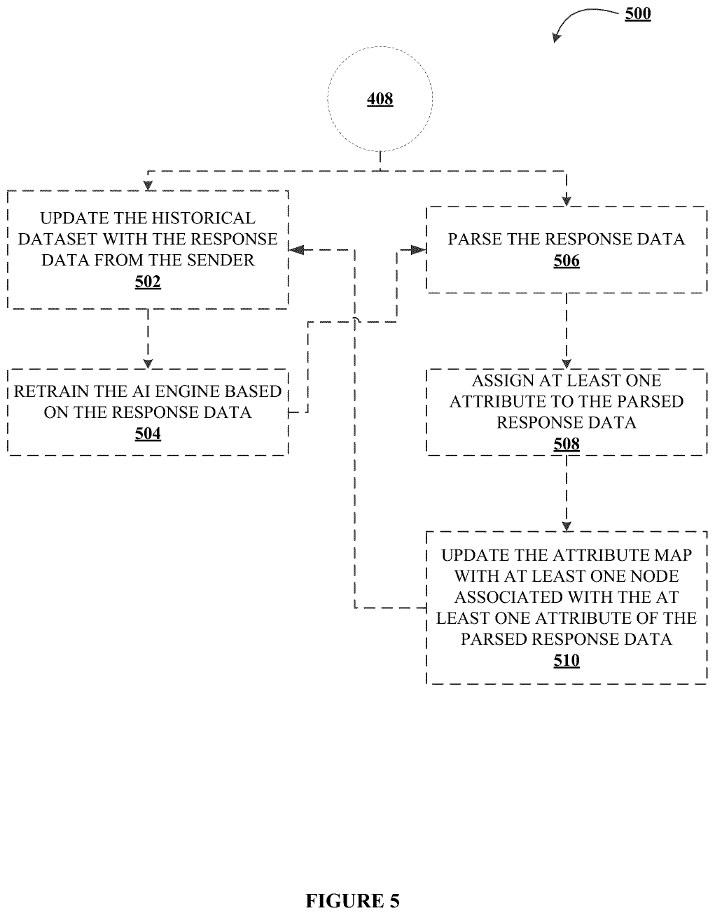

FIG. 5 illustrates a process flow 500 for training an AI engine with response data and/or updating the attribute map based on the response data, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500.

In some embodiments, and as shown in block 502, the process flow 500 may include the step of updating the historical dataset with the response data from the sender. For instance, and in some such embodiments, the system may update the historical dataset with the response data from the sender as the responses in the current data transmission period is received. In some embodiments, the collection and updating of the historical dataset may occur as each response is received, such that the updating of the historical dataset is continuous and up to date in real time or near real time to receiving the response data. In some embodiments, the system may wait until the current data transmission period has ended before updating the historical dataset with the response data, such that the historical dataset is updated only once or only a minimal number of times. In this manner, the system may conserve computing resources by only accessing and updating the historical datasets (e.g., only accessing the database comprising the historical datasets) and updating the historical datasets as minimally as possible.

In some embodiments, the system may first parse the response data after receiving the response data, and may store update the historical datasets by organizing the parsed response data into the appropriate historical datasets comprising each type of data (e.g., the response data may be parsed and separated based on what each piece of response data is used to determine whether to assign a particular attribute, and/or used for analysis in determining whether a secondary AI engine has been used). Thus, and in some such embodiments, a plurality of historical datasets may be stored and organized based on their data types and how the data is used by the system and its AI engine.

In some embodiments, and as shown in block 504, the process flow 500 may include the step of retraining the AI engine based on the response data. For example, and in some such embodiments, the system may retrain the AI engine with the response data once the response data has been used to update the historical dataset(s), whereby the updated historical dataset(s) may be reapplied (wholly or partially, e.g., only the new response data portions) to the AI engine for further training and refining. In this manner, the AI engine may be trained with up to date data and information as the response data is collected in real time, near real time, or as a collective. Thus, and in some embodiments, the response data may be used to iteratively train and automatically refine the AI engine.

Additionally, and/or alternatively, the process described herein with respect to blocks 502 and 504 may precede the process described herein with respect to blocks 506-510.

In some embodiments, and as shown in block 506, the process flow 500 may include the step of parsing the response data. For example, the system may parse the response data as it is received much in the same way as that described hereinabove with respect to block 502. Further, and based on this parsing and separating of the response data as it is received (and/or after it has been wholly collected), the system may assign an attribute to each piece of response data and/or to a collection of pieces of response data (e.g., for the use of determining whether to continue to assign the AI attribute, which may take more response data than just one piece).

As used herein, and in some such embodiments, each piece of data (as used in each piece of response data) may refer to a single unit of data, a variable, a term, a geolocation, a phone number, an IP address, a phrase, and/or the like.

In some embodiments, and as shown in block 508, the process flow 500 may include the step of assigning at least one attribute to the parsed response data. For instance, and in some embodiments, the system—using the AI engine—may assign an attribute to each piece of response data and/or an attribute to a collection of pieces of response data. In some embodiments, the response data may comprise pieces of data which is unnecessary for the known attributes of the AI engine, and the AI engine may instead choose to store these pieces of data in the historical dataset without an associated attribute. Such pieces of data may later be used by the AI engine to analyze and generate new attributes as new patterns are determined from analyzing current and future data transmission which may comprise similar pieces of data that do not align with any of the known attributes.

In this manner, the AI engine may continuously learn and analyze each piece of data that is received and/or identified by the system, and the AI engine may automatically and continuously find new patterns and create new attributes as patterns emerge in the data transmission data and response data. Such continuously and automatic learning by the AI engine allows the AI engine to create deeper knowledge of how each threat group improves their strategies, technical capabilities (with new technology, new third party source, and/or the like), and/or the like. Thus, the AI engine may continuously improve without needing manual intervention or tagging of new patterns.

In some embodiments, and as shown in block 510, the process flow 500 may include the step of updating the attribute map with at least one node associated with the at least one attribute of the parsed response data. For instance, and in some such embodiments, the system may update the attribute map with at least one node associated with the at least one newly assigned attribute from the parsed response data. Additionally, and/or alternatively, the system may update nodes already in the attribute map based on the assigned attributes of the response data, such that where a node is already generated within the attribute map to describe a particular attribute that the newly assigned attribute also matches (e.g., the assigned AI attribute may indicate the secondary AI generated some or all of the current data transmission), then the system may only update the node already in the attribute map with the new data of the response data. In this manner, nodes indicating the attributes will not be redundant in the attribute map, and further less computing resources may be needed to update the node as opposed to generating a whole new node with the same or similar attribute data.

Additionally, and in some such embodiments, the system may additionally update previous edges and/or add in at least one new edge for each new node within the attribute map. In this manner, the system may continuously keep an up to date attribute map with nodes and edges describing the assigned attributes and the associated edges indicating the links and/or relationships between the nodes.

Additionally, and/or alternatively, the process described herein with respect to blocks 506-510 may precede the process described herein with respect to blocks 502 and 504.

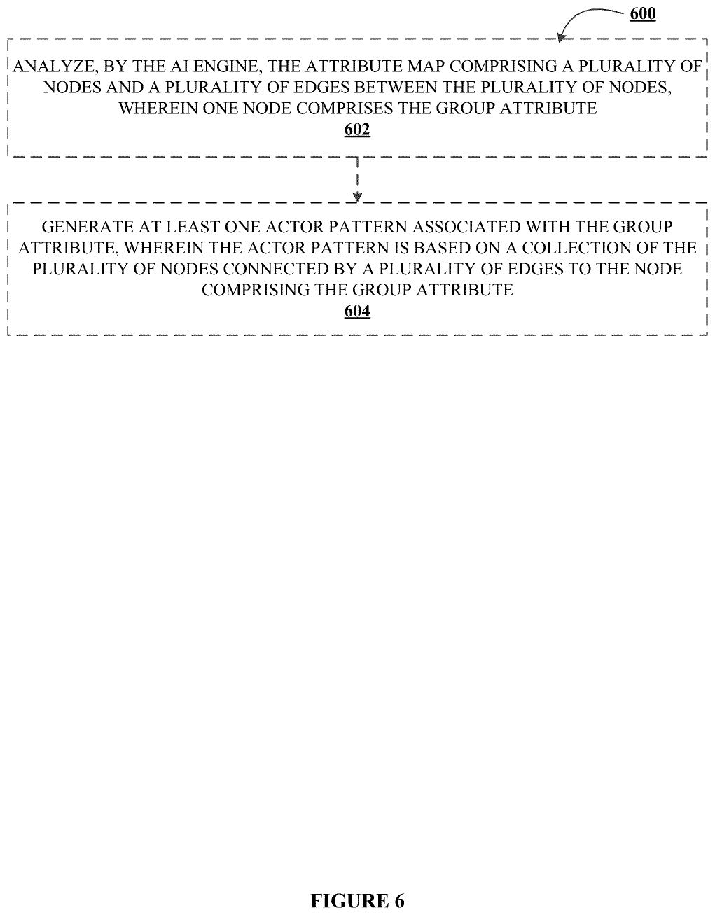

FIG. 6 illustrates a process flow 600 for generating an actor pattern associated with a group attribute, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600.

In some embodiments, and as shown in block 602, the process flow 600 may include the step of analyzing, by the AI engine, the attribute map comprising a plurality of nodes and a plurality of edges between the plurality of nodes, wherein one node comprises the group attribute. For instance, and in some such embodiments, the system may analyze—using the AI engine—the attribute map (such as the updated map described in FIG. 5 and/or the attribute map generated and/or updated in FIG. 3) and the attribute map's plurality of nodes and the edges connecting each of the plurality of nodes. Further, and based on this analysis, the AI engine may identify a node associated with a group attribute (or a plurality of nodes associated with a plurality of group attributes) and identify the nodes connected via edges to the group attribute node (and/or identify the each set of plurality of nodes associated with each group attribute node of the plurality of group attribute nodes, which may indicate a plurality of threat groups identified in the attribute map and their associated attribute nodes). In some embodiments, the group attribute nodes and their associated nodes may interconnect with other attribute notes of another group attribute node, such as where two threat groups have shared the same technology, the same AI engines, the same strategies, the same geolocation, the same IP address, and/or the like.

In some embodiments, and as shown in block 604, the process flow 600 may include the step of generating at least one actor pattern associated with the group attribute, wherein the actor pattern is based on a collection of the plurality of nodes connected by a plurality of edges to the node comprising the group attribute. Thus, and based on the AI engine's analysis, the system—using the AI engine—may generate an actor pattern for each threat actor group, whereby the actor pattern may indicate a pattern of activities, technology used, strategies, and/or the like, employed by each threat actor group. For example, and in some such embodiments, an actor pattern may indicate a standard procedure or standard strategy used by the threat actor to conduct a cyberattack attempt, a deepfake attempt, a vishing attempt, a malware attempt, and/or the like. Thus, and based on the attribute nodes for the group attribute node, the system may generate the actor pattern to indicate an overall scheme or process used by the threat actor groups, whether any threat actor patterns intersect using the same technology, third parties, AI engines, and/or the like.

Additionally, and in some embodiments, the actor pattern may comprise a temporal feature for each step in the actor pattern, whereby the temporal feature may comprise a synchronous or step-by-step pattern the threat actor typically follows in their attempts to access secure data. Such temporal features may be based on the data underlying each node and their associated assigned attributes and the data used to assign the attributes.

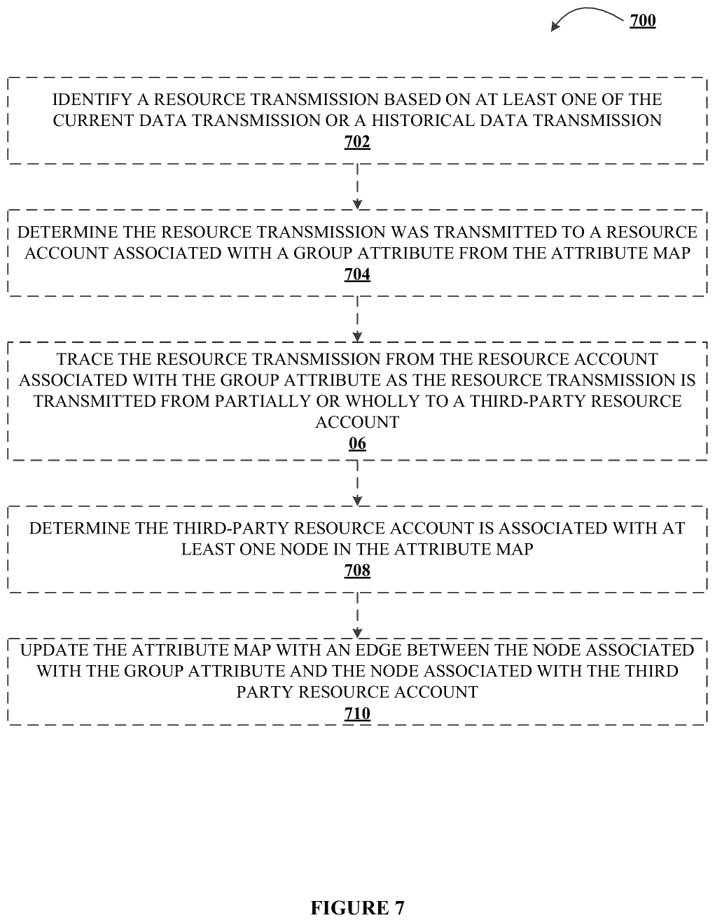

FIG. 7 illustrates a process flow 700 for updating the attribute map based on tracing a resource transmission, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700. In some embodiments, an artificial intelligence engine (e.g., such as the AI engine shown in FIG. 2) may perform some or all of the steps described in process flow 700.

In some embodiments, and as shown in block 702, the process flow 700 may include the step of identifying a resource transmission based on at least one of the current data transmission or a historical data transmission. For instance, the system may identify a resource transmission that was transmitted to a sender account of the current data transmission, such as a resource transmission that was made in response to the current data transmission. In some embodiments, the resource transmission may comprise a secure data resource, a monetary resource, and/or the like.

Additionally, and/or alternatively, the system may also identify historical resource or data transmissions that have occurred, but never been traced and/or are still in the process of being traced. Thus, and in some such embodiments, the system may identify and trace each of the resource transmissions and historical resource transmissions it has identified as being associated with a threat actor (e.g., a threat actor has received the resource transmission/historical data or resource transmissions).

In some embodiments, and as shown in block 704, the process flow 700 may include the step of determining the resource transmission was transmitted to a resource account associated with a group attribute from the attribute map. For instance, and in some such embodiments, the system may determine the resource transmission was transmitted to a resource account associated with a threat actor group (e.g., associated with a group attribute) from the attribute map, which may indicate that the resource transmission (or historical resource or data transmissions) was transmitted to a threat actor. Thus, and by identifying the group attribute within the attribute map that is associated with the recipient resource account, the system may definitively determine that the resource transmission was transmitted to a threat actor and was misappropriated (such as by vishing, cyberattack, deepfake, malware, and/or the like).

In some embodiments, the resource transmission may comprise a tracking component, such as but not limited to a trace identifier attached to the resource transmission, a resource identifier such as a serial number attached to the resource transmission, an IP address tracing, and/or the like.

In some embodiments, and as shown in block 706, the process flow 700 may include the step of tracing the resource transmission from the resource account associated with the group attribute as the resource transmission is transmitted from partially or wholly to a third-party resource account. Further the process described hereinabove, the system may additionally, and in some embodiments, trace (e.g., using a tracking component) the resource transmission as it moves from the resource account to a third-party resource account (e.g., which could be associated with another group attribute in the attribute map, and/or could be associated with a group unknown within the attribute map). In some embodiments, and in an instance where the third party resource account is not associated with a known group attribute node in the attribute map (e.g., the third party is unknown by the system), then the AI engine may generate a new group node for the third-party threat actor group now known to the system, and further may connect the group node of the resource account to the third-party group node of the third-party resource account in the attribute map.

Further, and in some embodiments, the system may continue to trace the resource transmission (as a whole or in portions) to third-party resource accounts as the resource transmission is transmitted between resource accounts. In this manner, the system may create a comprehensive view of each of the threat actors and their associations with other threat actors. As understood by a person of skill in the art, the use of a third-party resource account and third group is not meant to be limiting in the number of potential third parties that may receive all or a portion of the resource transmission, and instead is meant to be exemplary for the process that may occur in an instance where the resource transmission is transmitted each time.

In some embodiments, and as shown in block 708, the process flow 700 may include the step of determining the third-party resource account is associated with at least one node in the attribute map. For example, and in some embodiments, the system may determine the third-party resource account is associated with a current node in the attribute map, which itself may be used to determine that the third-party group associated with the third-party resource account is also a threat actor. Thus, and by comparing the resource accounts that receive the resource transmission (wholly or in part), the system may determine which are known threat actors and which are unknown threat actors that should be added to the attribute map for later tracking.

In some embodiments, and as shown in block 710, the process flow 700 may include the step of updating the attribute map with an edge between the node associated with the group attribute and the node associated with the third party resource account. For instance, and in some embodiments, the system may update the attribute map with the data of the resource transmission, how the resource transmission was used, and if the resource transmission was transmitted to another third party. Thus, the attribute map may comprise a full picture of each of the threat actors, their attributes (which may show their capabilities, strategies, associations with other threat actors, other third parties, and/or the like).

### Example Use Cases

Additionally, and in some embodiments where the system described herein is attempting to determine a particular type of threat or misappropriation attempt, such as a deepfake attempt whereby a threat actor (either through manual means and/or AI means) generates a digitally altered or a brand new digital rendering of a human actor (and/or a digital voice rendering) to impersonate a known actor, then the system may identify a particular set of input data from the current data transmission comprising the potential deepfake. Such input data that may be collection may comprise at least one of a time, a date, a call origin, a call destination, a call duration, and/or a call type. In some such embodiments, the AI engine of the system may be trained to analyze the input data by determining if the phone number is linked with one or group attributes, whether the communication service provider is linked with one or more group attributes, the recent activity of linked with the phone number (e.g., SIM swap, porting, forwarding, and/or the like), a phone number reputation scoring (e.g., spoofing, robocalling, and/or the like), whether the caller is new or unknown, the history of previous communication channels (e.g., phone, text, emails, and/or the like), call frequency, call frequency and velocity (e.g., caller contacted x number of receives in y amount of time), speaker recognition, speech recognition, un-natural speech patterns (e.g., urgency, grammar, evenly spaced pauses every time), request for sensitive information (e.g., personally identifying information, resource account credentials), and/or the like.

Additionally, and in some embodiments as the AI engine analyzes the input of a potential deepfake the AI engine may output new or altered signatures and/or behaviors linked with the group attribute; a confidence score; whether the call is malicious, legitimate, or unknown; a classification of the call as social engineering, vishing, data misappropriation, and/or the like; assign attribute(s); disruption activities; and/or the like. Additionally, and/or alternatively, the system—using the AI engine—may also generate a warning notification for the user device associated with the recipient of the current data transmission, take over the communication with the AI engine, identify a secondary AI engine and/or what type, identify if a human contributed to the generation of the current data transmission with or without the secondary AI engine, and/or gather data by applying the AI engine to the communication with the sender of the current data transmission.

Additionally, and in some embodiments, the system may—using the AI engine—analyze the input data of the current data transmission in an instance where the current data transmission is associated with a malware attack and/or a social engineering cyberattack attempt. In some such embodiments, the input data may comprise a time, a date, a source IP address, a destination IP address, a sender identifier, a sender domain, a reply to domain, a recipient identifier, a recipient domain, a subject (such as a subject line or file name), a message content, attachments, links, a Domain-based Message Authentication Reporting & Conformance (DMARC), DomainKeys Identified Mail (DKIM), an X-mailer, and/or the like. Thus, and by applying one or more of these inputs to the AI engine, the AI engine may analyze the inputs and determine a history of pervious communication channels (phone, text, email); message frequency; sender velocity and frequency; header analysis; intel feeds; and/or the like.

Thus, and in some such embodiments, the AI engine may perform its analysis on the input data of the potential malware attack and/or social engineering cyberattack attempt, and generate an output such as but not limited to new or altered signatures or behavior patterns of the sender; confidence score; malicious, legitimate, or unknown classifiers for the data transmission; classification of the current data transmission as social engineering, malware, social engineering cyberattack attempt, and/or the like; attribute assignment; disruption activities; and/or the like. Additionally, and/or alternatively, the system—using the AI engine—may also generate a warning notification for the user device associated with the recipient of the current data transmission, take over the communication with the AI engine, identify a secondary AI engine and/or what type, identify if a human contributed to the generation of the current data transmission with or without the secondary AI engine, and/or gather data by applying the AI engine to the communication with the sender of the current data transmission.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for identifying data security threats and dynamically generating vulnerability solutions, the system comprising:
a memory device with computer-readable program code stored thereon;
at least one processing device operatively coupled to the at least one memory device and the at least one communication device, wherein executing the computer-readable code is configured to cause the at least one processing device to:
identify a current data transmission;
apply the current data transmission to an artificial intelligence (AI) engine, wherein the AI engine is pre-trained with at least one historical dataset;
assign, by the AI engine, at least one attribute to the current data transmission, wherein the at least one attribute comprises a group attribute, technology attribute, an AI attribute, or a network attribute; and
generate, based on the assigned at least one attribute to current data transmission, an attribute map, wherein the attribute map comprises an attribute node for each of the at least one attribute, and at least one edge between at least two attribute nodes.

2. The system of claim 1, wherein the at least one attribute map comprises a group attribute set which comprises a plurality of attributes comprising at least one of the technology attribute, the AI attribute, the network attribute.

3. The system of claim 1, wherein the at least one historical dataset comprises at least one of threat positive internal historical data, threat negative internal historical data, public historical data, or darknet historical data.

4. The system of claim 1, wherein the current data transmission comprises at least one of a text message data transmission, an electronic mail data transmission, an audio data transmission, an audio-visual data transmission, or a software data transmission.

5. The system of claim 1, wherein executing the computer-readable code is further configured to cause the at least one processing device to:
determine the current data transmission has been assigned the AI attribute indicating the current data transmission is generated by a secondary AI engine, wherein the AI attribute assignment is based on a confidence level of the AI engine or a AI positive threshold;
apply, based on the assigned AI attribute to the current data transmission, the AI engine to the current data transmission;
trigger, based on applying the AI engine to the current data transmission, at least one AI-generated communication to a sender of the current data transmission; and
collect response data from the sender based on the at least one AI-generated communication.

6. The system of claim 5, wherein executing the computer-readable code is further configured to cause the at least one processing device to:
update the historical dataset with the response data from the sender; and
retrain the AI engine based on the response data.

7. The system of claim 5, wherein executing the computer-readable code is further configured to cause the at least one processing device to:
parse the response data;
assign at least one attribute to the parsed response data; and
update the attribute map with at least one node associated with the at least one attribute of the parsed response data.

8. The system of claim 1, wherein executing the computer-readable code is further configured to cause the at least one processing device to:
analyze, by the AI engine, the attribute map comprising a plurality of nodes and a plurality of edges between the plurality of nodes, wherein one node comprises the group attribute; and
generate at least one actor pattern associated with the group attribute, wherein the actor pattern is based on a collection of the plurality of nodes connected by a plurality of edges to the node comprising the group attribute.

9. The system of claim 1, wherein executing the computer-readable code is further configured to cause the at least one processing device to:
identify a resource transmission based on at least one of the current data transmission or a historical data transmission;
determine the resource transmission was transmitted to a resource account associated with a group attribute from the attribute map;
trace the resource transmission from the resource account associated with the group attribute as the resource transmission is transmitted partially or wholly to a third-party resource account;
determine the third-party resource account is associated with at least one node in the attribute map; and
update the attribute map with an edge between the node associated with group attribute and node associated with the node associated with the third-party resource account.

10. A computer program product for identifying data security threats and dynamically generating vulnerability solutions, the computer program product comprising a non-transitory computer-readable medium comprising code causing an apparatus to:
identify a current data transmission;
apply the current data transmission to an artificial intelligence (AI) engine, wherein the AI engine is pre-trained with at least one historical dataset;
assign, by the AI engine, at least one attribute to the current data transmission, wherein the at least one attribute comprises a group attribute, technology attribute, an AI attribute, or a network attribute; and
generate, based on the assigned at least one attribute to current data transmission, an attribute map, wherein the attribute map comprises an attribute node for each of the at least one attribute, and at least one edge between at least two attribute nodes.

11. The computer program product of claim 10, wherein the at least one attribute map comprises a group attribute set which comprises a plurality of attributes comprising at least one of the technology attribute, the AI attribute, the network attribute.

12. The computer program product of claim 10, wherein the at least one historical dataset comprises at least one of threat positive internal historical data, threat negative internal historical data, public historical data, or darknet historical data.

13. The computer program product of claim 10, wherein the at least one historical dataset comprises at least one of threat positive internal historical data, threat negative internal historical data, public historical data, or darknet historical data.

14. The computer program product of claim 10, wherein the current data transmission comprises at least one of a text message data transmission, an electronic mail data transmission, an audio data transmission, an audio-visual data transmission, or a software data transmission.

15. The computer program product of claim 10, wherein the computer program product further comprises non-transitory computer-readable medium comprising code causing the apparatus to:
determine the current data transmission has been assigned the AI attribute indicating the current data transmission is generated by a secondary AI engine, wherein the AI attribute assignment is based on a confidence level of the AI engine or a AI positive threshold;
apply, based on the assigned AI attribute to the current data transmission, the AI engine to the current data transmission;
trigger, based on applying the AI engine to the current data transmission, at least one AI-generated communication to a sender of the current data transmission; and
collect response data from the sender based on the at least one AI-generated communication.

16. A computer implemented method for identifying data security threats and dynamically generating vulnerability solutions, the computer implemented method comprising:
identifying a current data transmission;
applying the current data transmission to an artificial intelligence (AI) engine, wherein the AI engine is pre-trained with at least one historical dataset;
assigning, by the AI engine, at least one attribute to the current data transmission, wherein the at least one attribute comprises a group attribute, technology attribute, an AI attribute, or a network attribute; and
generating, based on the assigned at least one attribute to current data transmission, an attribute map, wherein the attribute map comprises an attribute node for each of the at least one attribute, and at least one edge between at least two attribute nodes.

17. The computer implemented method of claim 16, wherein the at least one attribute map comprises a group attribute set which comprises a plurality of attributes comprising at least one of the technology attribute, the AI attribute, the network attribute.

18. The computer implemented method of claim 16, wherein the at least one historical dataset comprises at least one of threat positive internal historical data, threat negative internal historical data, public historical data, or darknet historical data.

19. The computer implemented method of claim 16, wherein the current data transmission comprises at least one of a text message data transmission, an electronic mail data transmission, an audio data transmission, an audio-visual data transmission, or a software data transmission.

20. The computer implemented method of claim 16, further comprising:
determining the current data transmission has been assigned the AI attribute indicating the current data transmission is generated by a secondary AI engine, wherein the AI attribute assignment is based on a confidence level of the AI engine or a AI positive threshold;
applying, based on the assigned AI attribute to the current data transmission, the AI engine to the current data transmission;
triggering, based on applying the AI engine to the current data transmission, at least one AI-generated communication to a sender of the current data transmission; and
collecting response data from the sender based on the at least one AI-generated communication.
